(19) United States
(12) Patent Application Publication
(10) Pub. No.: US 2015/0272197 A1
(43) Pub. Date: Oct. 1, 2015

(54) CONTAINER

(71) Applicant: ROBINSONS SOFT DRINKS LIMITED, Hemel Hempstead (GB)

(72) Inventors: Michael Anthony SWAIN, Hemel Hempstead (GB); William George DANDO, Hemel Hempstead (GB); Peter Antony FARRAR, Leeds (GB)

(73) Assignee: ROBINSONS SOFT DRINKS LIMITED, Hemel Hempstead (GB)

(21) Appl. No.: 14/674,062

(22) Filed: Mar. 31, 2015

Related U.S. Application Data
(60) Provisional application No. 61/972,813, filed on Mar. 31, 2014.

(51) Int. Cl. A23L 2/385; B65D 83/00; B65D 1/02

(52) U.S. Cl. CPC A23L 2/385; B65D 1/02; B65D 83/00; A23V 2002/00

(57) ABSTRACT

The present disclosure relates to a container for dispensing a flowable substance, more particularly a container for dispensing multiple doses of a flowable substance. Typically, the flowable substance may comprise a liquid concentrate, e.g. a liquid beverage concentrate.

This application claims benefit under 35 U.S.C. §119(e) of U.S. Provisional Application No. 61/972,813, filed Mar. 31, 2014, the content of which is incorporated herein by reference in its entirety.

The present disclosure relates to a container for dispensing a flowable substance, more particularly a container for dispensing multiple doses of a flowable substance. Typically, the flowable substance may comprise a liquid concentrate, e.g. a liquid beverage concentrate.

Typically, a container for dispensing a liquid concentrate may comprise a container body coupled with a closure. The closure may comprise a cap body, an orifice and a closable lid.

An advantage of liquid concentrates is that the size and amount of packaging to supply a desired quantity of end result product may be significant reduced (as compared with non-concentrated liquids). As a consequence, packaging, transport and/or storage costs may be reduced.

Liquid concentrates can include concentrated amounts of dye so that after mixing, typically with water, the end result product has a desired colour. These dyes can stain surfaces such as clothes and skin, if the liquid concentrate comes into contact with the surface. Therefore, a container for dispensing multiple doses of a liquid concentrate should facilitate increased control, repeatability, consistency of delivery and reduced likelihood of mess than would a standard pouring container.

It is desirable that a container for dispensing a liquid concentrate does not leak. Furthermore, it is desirable for a container for dispensing a liquid concentrate to be robust, e.g. it should not be easy to open the container by removing the closure from the container. In addition, it is desirable for a container for dispensing a liquid concentrate to facilitate cleaner delivery of the liquid concentrate.

An aspect of the technology described herein provides a container for dispensing multiple doses of a flowable substance comprising: a container body defining an internal volume for holding the flowable substance and an outlet from the internal volume; and a closure coupled to the container body, the closure comprising an orifice in fluid communication with the outlet; wherein the container body and the closure are configured such that a torque in excess of 1.5 ft.lbs is required to be applied in order to remove the closure from the container body by twisting.

Advantageously, the torque required to be applied in order to remove the closure from the container body by twisting is greater than the torque a human can typically apply manually. Thus, the container may be especially robust and resistant to accidental opening, which may be especially advantageous when the container is used to hold and deliver multiple doses of a liquid concentrate, e.g. a liquid beverage concentrate.

In some embodiments, the torque required to be applied in order to remove the closure from the container body by twisting may be 2 ft.lbs or more, 3 ft.lbs or more, 4 ft.lbs or more or 5 ft.lbs or more.

In some embodiments, the container body and/or the closure may comprise at least one anti-rotation feature, operable to resist, in use, rotation of the closure with respect to the container body.

In some embodiments, the closure may comprise a cap body.

The closure may comprise a closable lid, e.g. a flip lid, operable, in use, to cover and uncover the orifice.

The closable lid may be connected to the cap body, e.g. by a hinge.

An aspect of the technology described herein provides a container for dispensing multiple doses of a flowable substance comprising:
a container body defining an internal volume for holding the flowable substance and a neck comprising a bore defining an outlet from the internal volume;
a closure coupled to the container body, the closure comprising an orifice in fluid communication with the outlet and an annular wall configured to provide, in use, a bore plug seal within the bore;
   wherein there is an interference fit between the annular wall and the bore and, optionally, the force required to decouple the closure from the container body by linearly pulling the closure off the container body is greater than 9 lb. The outer diameter of the annular wall may be at least 0.008 inches greater than the inner diameter of the bore, e.g., at least 0.008 inches, at least 0.010 inches, at least 0.012 inches, at least 0.014 inches, at least 0.016 inches, at least 0.018 inches, at least 0.019 inches, at least 0.02 inches, at least 0.022 inches, at least 0.024 inches, at least 0.026 inches, at least 0.027 inches, at least 0.028 inches or at least 0.030 inches. In one embodiment, the outer diameter of the annular wall may be at least 0.019 to 0.027 inches greater than the inner diameter of the bore. In an embodiment, the outer diameter of the annular wall may be at least 0.02 inches greater than the inner diameter of the bore. The difference between the outer diameter of the annular wall and the inner diameter of the bore may be in the range 0.02 inches to 0.2 inches, e.g., 0.024 inches to 0.031 inches, 0.02 inches to 0.03 inches, 0.02 inches to 0.035 inches, 0.02 inches to 0.04 inches, 0.02 inches to 0.06 inches, 0.02 inches to 0.08 inches, 0.02 inches to 0.10 inches, 0.02 inches to 0.12 inches, 0.02 inches to 0.14 inches, 0.02 inches to 0.16 inches, or 0.02 inches to 0.18 inches. The difference in diameter is preferably such that when the closure is fitted to the container, a force of greater than 9 lb is required to decouple the closure from the container body by linearly pulling the closure off the container body.

In an embodiment, on the outside of the annular wall, there may be an at least partially circumferential ridge, which locally increases the outer diameter of the annular wall. The at least partially circumferential ridge may increase the local outer diameter of the annular wall by 0.004 inches to 0.008 inches, e.g., 0.004 inches, 0.005 inches, 0.006 inches, 0.007 inches or 0.008 inches.

In an embodiment, the annular wall and the bore may be made from the same or chemically similar polymeric materials, in order to allow or to promote the occurrence of seize. For example, the annular wall and the bore may both be made from polypropylene or polyethylene.

The closure may further comprise one or more arcuate clip features configured to engage with an outer wall of the neck. The arcuate clip features may be provided with one or more outer reinforcing ribs.

The or each arcuate clip feature may further comprise one or more bumps configured to pass over a ramp formation on the neck when the closure is coupled with the container body.

Another aspect of the technology described herein comprises a container for dispensing multiple doses of a flowable substance comprising: a container body defining an internal volume for holding the flowable substance and an outlet from the internal volume; and a closure coupled to the container body, the closure comprising an orifice in fluid communication with the outlet; wherein the container body and/or the closure comprises at least one anti-rotation feature, operable to resist, in use, rotation of the closure with respect to the container body.

In an embodiment, the container body and the closure may be configured such that a torque in excess of 1.5 ft.lbs is required to be applied in order to remove the closure from the container body by twisting.

The anti-rotation feature may comprise one or more protrusions, e.g. shoulder formations, provided on the container body or in the closure and one or more slots or gaps provided on or in the other of the container body and the closure, the protrusion(s) being receivable within the slot(s) or gap(s) such that, in use, the protrusion(s) and the slot(s) or gap(s) interact to resist rotation of the closure relative to the container body.

Another embodiment of the technology described herein provides a packaged flowable substance comprising a container as described herein with a plurality of doses of the flowable substance therein. Conveniently, the flowable substance may be a liquid concentrate, e.g. a beverage liquid concentrate.

Features from one aspect or embodiment of the technology described herein may be combined with features from other aspects or embodiments of the technology described herein without departing from the spirit and scope of the invention.

Seize is a phenomenon which occurs when components made from similar polymeric materials are brought together, e.g. due to an interference fit. Typically, components are designed and engineered to avoid or minimise seize occurring, e.g. by selecting chemically dissimilar materials for components which will come into contact with one another, in use. In contrast, the technology described herein is designed and engineered to promote seize, by selecting similar polymeric materials for components which come into contact in use and/or by engineering an increased interference fit between said components.

In order that the technology described herein may be well understood, it will now be described by way of example only with reference to the accompanying drawings:

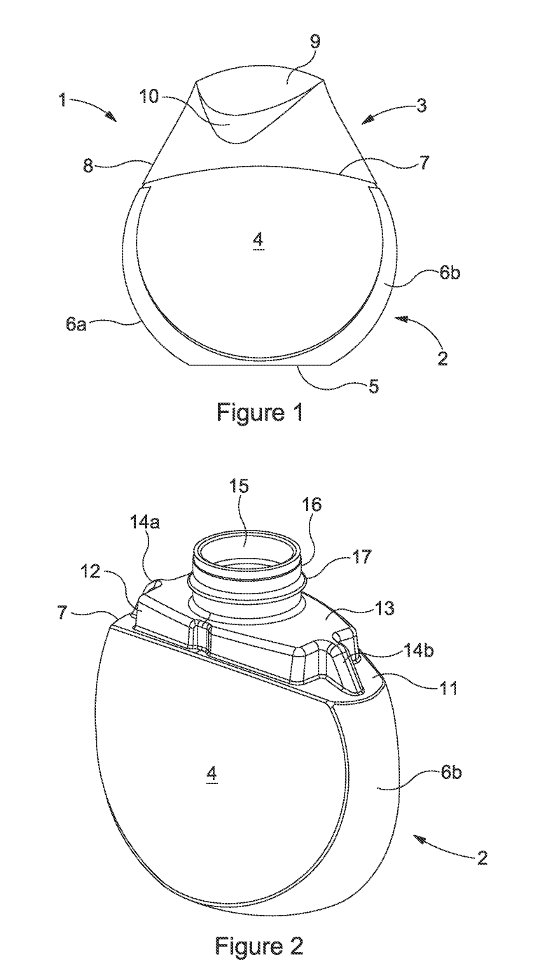

FIG. 1 is a front elevation of an embodiment of a container according to the invention;

FIG. 2 shows an embodiment of a container body according to the invention;

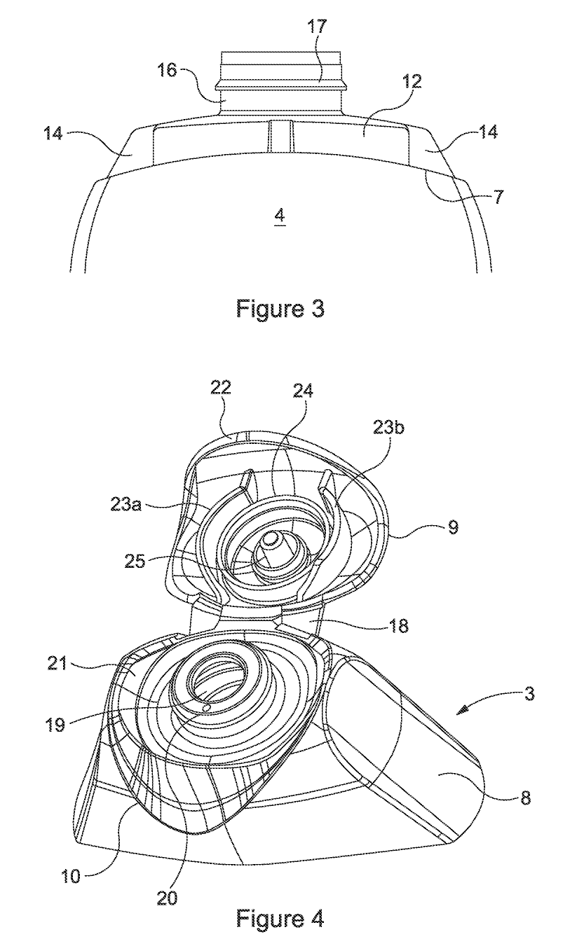

FIG. 3 shows an upper portion of an embodiment of a container body according to the invention;

FIG. 4 shows an embodiment of a closure according to the invention;

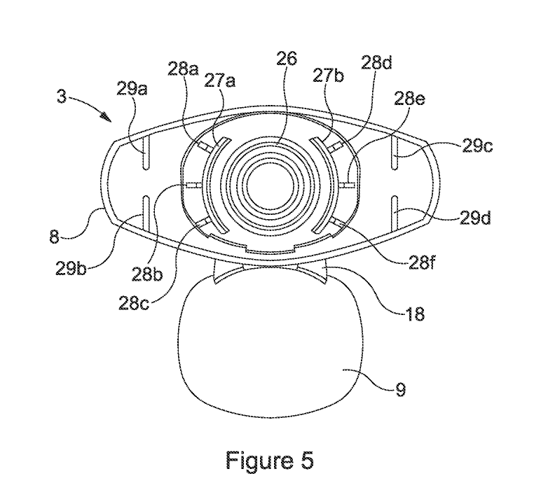

FIG. 5 shows a view of the underside of a first embodiment of a closure according to the invention;

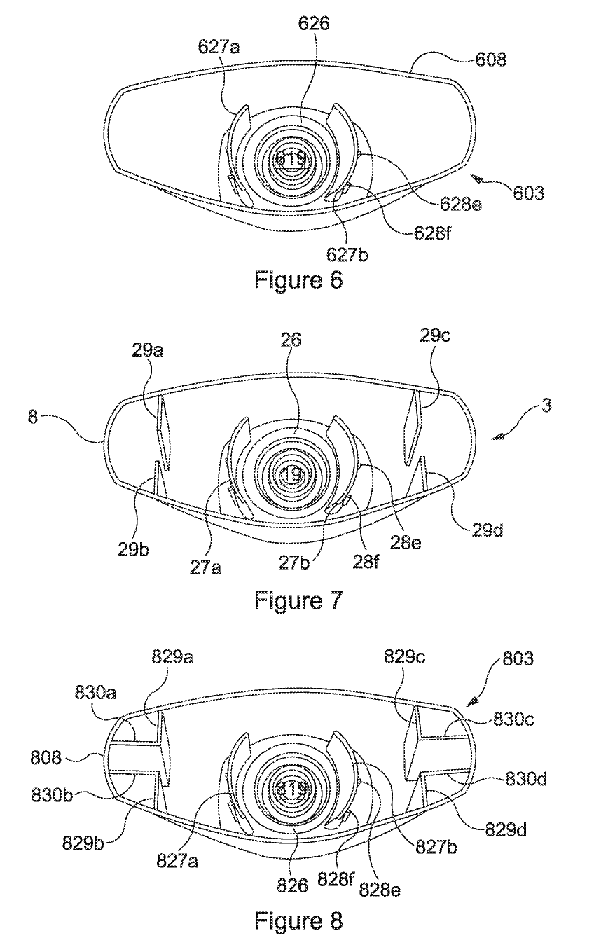

FIG. 6 shows a view of the underside of a second embodiment of a closure according to the invention;

FIG. 7 shows a second view of the underside of the first embodiment of a closure according to the invention;

FIG. 8 shows a view of the underside of a fourth embodiment of a closure according to the invention;

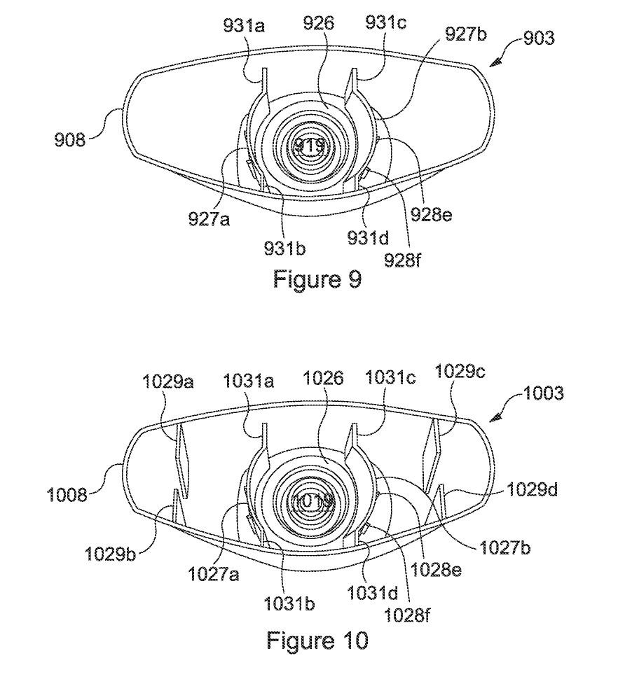

FIG. 9 shows a view of the underside of a fifth embodiment of a closure according to the invention; and

FIG. 10 shows a view of the underside of a sixth embodiment of a closure according to the invention.

FIG. 1 shows a front elevation of a container 1 according to one embodiment of the technology described herein. The container 1 comprises a container body 2 and a closure 3 coupled to the container body 2. Typically, the container body 2 and the closure 3 may be made from a polymeric material. In some embodiments, the container body 2 and the closure 3 may be made from the same polymeric material, e.g. the container body 2 and the closure 3 may be made from polypropylene. The container body 2 and the closure 3 may be manufactured by any suitable method, e.g. extrusion blow moulding (EBM), injection moulding and the like.

The container body 2 has an internal volume for holding, in use, a product, intended to be dispensed from the container 1 in multiple doses. The product may comprise a flowable substance, typically a liquid concentrate, e.g. a liquid beverage concentrate.

The internal volume of the container body 2 may be any size. In an embodiment, the internal volume of the container body 2 may be configured to hold 2.2 fl oz of product.

The container body 2 comprises a stable base 5, which allows the container 1 to stand upright, in use. Extending upwardly from the base 5, there is a front panel 4, a rear panel (not shown) opposite the front panel 4 and having the same general shape as the front panel 4 and a pair of curved side panels 6a, 6b. A perimeter bearing surface 7 joins the tops of the front panel 4, the rear panel and the curved side panels 6a, 6b. The perimeter bearing surface 7 is bowed from each of the side panels 6a, 6b to a highest point around the centre of the front panel 4 and the rear panel.

Typically, the container body may be made at least partially from a resilient material, e.g. polypropylene. The container body may comprise at least one resilient or flexible portion, e.g. a resilient wall or part thereof. For instance, the front panel and/or the rear panel of the container body may be formed from a resilient material. In use, multiple doses of a flowable substance may be dispensed from the container by repeatedly squeezing the resilient or flexible portions.

Conveniently, information regarding the product within the container may be provided on one or more stickers stuck to the container body and/or the closure, e.g. to the front panel and/or the rear panel. Additionally or alternatively, at least a portion of the container body and/or the closure may be provided in a sleeve, e.g. at least a portion of the container body and/or the closure may be shrink-wrapped.

As can be seen in FIG. 1, the closure 3 comprises a cap body 8. The cap body 8 fits on to the container body 2. The bottom rim of the cap body 8 abuts and conforms to the shape of the perimeter bearing surface 4. The cap body 8 tapers inwards from the sides towards its top, where there is a flip lid 9. An assymetric depression 10 located off-centre on the front of the cap body 8 allows a user to access the edge of the flip lid 9 with a finger or thumb, in order to open the flip lid 9.

Referring to FIGS. 2 and 3, the top of the container body 2 can be seen in more detail. Within the perimeter bearing surface 7, there is a step 12 comprising substantially vertical walls rising upwards to a top surface 13. In an embodiment, the step may be from 4 mm to 10 mm high. At each end of the step 12, there is a thin shoulder formation 14a, 14b extending outwardly and tapering down to a surface 11 between the bases of the shoulders 14a, 14b and the perimeter bearing surface 7.

A cylindrical neck 16 defining a bore 15 extends upwardly from the centre of the top surface 13 of the step 12. The bore 15 provides an outlet from the internal volume of the container body 2. A circumferential ramp formation 17 is located around the outside of the neck 16 and around half-way up the neck 16.

It will be appreciated that the container body 2 may have a general shape other than that of the example embodiment shown in the Figures.

Further details of the closure 3 can be seen in FIG. 4. The flip lid 9 is connected to the cap body 8 by a hinge 18. The rim of flip lid 9 comprises a tongue 22, which, when the flip lid 9 is closed, is received within the depression 10 such that a user can open the flip lid 9 by accessing the tongue 22 with a thumb or finger. As can be seen in FIG. 4, the underside of the flip lid 9 comprises a stopper 25 at its centre. The stopper 25 is surrounded by an annular wall 24, outside which is located a pair of arcuate clip feature walls 23a, 23b.

The top of the cap body 8 and the edge of the depression 10 form a rim. Within this rim, there is an upper surface 21. A cap body neck 20 extends upwardly from the centre of the upper surface 21. The cap body neck 20 defines an orifice 19. Typically, the orifice 19 may be provided with a control device, e.g. a smaller orifice, a collimator tube, a baffled orifice, a valve (e.g. a silicone valve) or a nozzle.

The flip lid 9 is configured to engage with the cap body 8 by a snap-fit. An audible or tactile feedback cue occurs when, in use, the flip lid 9 is opened and closed. When the flip lid 9 is closed, the stopper 25 is received in the orifice 19 and the annular wall 24 grips the cap body neck 20. There is an interference fit between the cap body neck 20 and the annular wall 24.

FIGS. 5 and 7 show the underside of the closure 3. The cap body 8 is connected to the flip lid 9 by the hinge 18. Within the cap body 8, there are several formations and features. The orifice 19 is surrounded by an annular wall 26. When the closure 3 is coupled to the container body 2, the annular wall 26 plugs the bore 15. An interference fit between the annular wall 26 and the bore 15 provides a bore plug seal. On the outside of the annular wall 26, there is a rounded circumferential ridge, which locally increases the outer diameter of the annular wall 26. The rounded circumferential ridge may increase the local outer diameter of the annular wall by around 0.004 inches or around 0.008 inches. The rounded circumferential ridge acts to increase the interference fit between the annular wall 26 and the bore 15. There may be an audible click when the annular wall 26 and the bore 15 are brought into and out of engagement.

The rounded circumferential ridge also acts to promote seize between the annular wall 26 and the bore 15, which is further promoted by selecting similar polymeric materials for the annular wall 26 and the bore 15. For instance, the annular wall 26 and the bore 15 may both be made from polypropylene.

By providing an enhanced interference fit and/or increased seize, the bore plug seal may be improved. Consequently, the container 1 may be less prone to leaking than prior art containers.

In an embodiment, the bore may have an inner diameter of around 0.673 inches and the annular wall may have an outer diameter of around 0.697 inches, increasing locally to around 0.704 inches at the circumferential ridge. It will be appreciated that an interference fit of such dimensions is towards the higher end of typical interference fits designed and engineered into closures for containers such as bottles or the like. By using such a tight interference fit, seize may be promoted, further improving the bore plug seal and/or further increasing resistance to uncoupling the closure from the container body, whether by twisting or rotation and/or a linear pull.

In an embodiment, the bore may have an inner diameter of around 0.394 inches and the annular wall may have an outer diameter of around 0.413 inches, increasing locally to around 0.421 inches at the circumferential ridge. It will be appreciated that an interference fit of such dimensions is towards the higher end of typical interference fits designed and engineered into closures for containers such as bottles or the like. By using such a tight interference fit, seize may be promoted, further improving the bore plug seal and/or further increasing resistance to uncoupling the closure from the container body by a linear pull.

Outside the annular wall 26, there are two arcuate clip features 27a, 27b. The arcuate clip features 27a, 27b are taller than the annular wall 26. The rigidity of the arcuate clip features 27a, 27b is improved by the provision of substantially vertical outer reinforcing ribs 28a, 28b, 28c, 28d, 28e, 28f. On the inner side of each arcuate clip feature 27a, 27b, there is an elongate bump (not shown). The elongate bumps are configured such that, when the closure 3 is coupled to the container body 2, the elongate bumps have passed over the ramp formation 17. Accordingly, the bumps engage with the ramp formation to resist removal of the closure 3 from the container body 2. The provision of the outer reinforcing ribs may increase the strength of the arcuate clip features' engagement with the neck of the container body, thereby providing additional or alternative resistance to removal of the closure 3 from the container body 2.

Within the cap body 8, there are also four anti-rotation ribs 29a, 29b, 29c, 29d. In use, anti-rotation ribs 29a, 29b sit either side of shoulder formation 14a and anti-rotation ribs 29c, 29d sit either side of shoulder formation 14b.

Beneficially, the anti-rotation ribs 29a, 29b, 29c, 29d may also serve a useful alignment function during assembly of the container. When coupling the closure to the container body (i.e. after the container body has been filled with product), the anti-rotation ribs help to properly locate and align the closure and the container body. Accordingly, manual, semi-automated and/or automated assembly techniques may be facilitated by the presence of the anti-rotation ribs.

The container 1 has been designed in order to be robust. In particular, it is especially difficult to remove the closure 3 from the container bottle 2 by twisting, due to the provision of several anti-rotation features. The bowed shape of the perimeter bearing surface acts to resist twisting of the closure 3 relative to the container bottle 2. The step 12 acts to resist twisting of the closure 3 relative to the container bottle 2. The anti-rotation ribs 29a, 29b, 29c, 29d and the shoulder formations 14a, 14b interact to resist twisting of the closure 3 relative to the container bottle 2.

In some embodiments, 20-80% of the torque resistance of the container (i.e. the resistance to removal of the closure from the container body by twisting) may be a result of the interaction of the anti-rotation ribs with the shoulder formations.

In some embodiments, 20-80% of the torque resistance may be a result of the selected interference fit between the annular wall and the inner surface of the bore.

Some embodiments of the technology described herein may not contain all of these anti-rotation features. Embodiments of the technology described herein may comprise any number of these anti-rotation features.

The container is specifically engineered and designed such that the linear pull required to remove the closure from the container body is relatively high. The applicant's experiments indicate that for a container comprising the container body of FIG. 2 and the closure of FIG. 5 or FIG. 7, the engagement of the arcuate clip features with the ramp formation may contribute to about a third of the resistance to removal of the closure by a linear pull, while the selected interference fit and seize between the annular wall and the inner surface of the bore may contribute to about two-thirds of the resistance to removal of the closure by a linear pull.

FIG. 6 shows a view of the underside of a second example embodiment of a closure 603 according to the invention. The closure 603 comprises a cap body 608 having the same tapered general shape as described earlier in relation to other example embodiments. The embodiment shown in FIG. 6 is identical to the embodiment shown in FIGS. 5 and 7, except that it does not include any anti-rotation ribs.

Within the cap body 608, there are several formations and features. An orifice 619 is surrounded by an annular wall 626. When the closure 603 is coupled to the container body 2, the annular wall 626 plugs the bore 15. An interference fit between the annular wall 626 and the bore 15 provides a bore plug seal. On the outside of the annular wall 626, there is a rounded circumferential ridge, which locally increases the outer diameter of the annular wall 626. The rounded cicumferential ridge may increase the local outer diameter of the annular wall by around 0.004 inches or around 0.008 inches. The rounded circumferential ridge acts to increase the interference fit between the annular wall 626 and the bore 15. There may be an audible click when the annular wall 626 and the bore 15 are brought into and out of engagement.

The rounded circumferential ridge also acts to promote seize between the annular wall 626 and the bore 15, which is further promoted by selecting similar polymeric materials for the annular wall 626 and the bore 15. For instance, the annular wall 626 and the bore 15 may both be made from polypropylene.

By providing an enhanced interference fit and/or increased seize, the bore plug seal may be improved. Consequently, the container 1 may be less prone to leaking than prior art containers.

Outside the annular wall 626, there are two arcuate clip features 627a, 627b. The arcuate clip features 627a, 627b are taller than the annular wall 626. The rigidity of the arcuate clip features 627a, 627b is improved by the provision of six substantially vertical outer reinforcing ribs (only two of the outer reinforcing ribs 628e, 628f are labelled for clarity). On the inner side of each arcuate clip feature 627a, 627b, there is an elongate bump (not shown). The elongate bumps are configured such that, when the closure 603 is coupled to the container body 2, the elongate bumps have passed over the ramp formation 17. Accordingly, the bumps engage with the ramp formation to resist removal of the closure 603 from the container body 2.

FIG. 8 shows a view of the underside of a third example embodiment of a closure 803 according to the invention. The closure 803 comprises a cap body 808 having the same tapered general shape as described earlier in relation to other example embodiments. The embodiment shown in FIG. 8 is identical to the embodiment shown in FIGS. 5 and 7, except that it includes four connecting ribs 830a, 830b, 830c, 830d.

Within the cap body 808, there are several formations and features. An orifice 819 is surrounded by an annular wall 826. When the closure 803 is coupled to the container body 2, the annular wall 826 plugs the bore 15. An interference fit between the annular wall 826 and the bore 15 provides a bore plug seal. On the outside of the annular wall 826, there is a rounded circumferential ridge, which locally increases the outer diameter of the annular wall 826. The rounded cicumferential ridge may increase the local outer diameter of the annular wall by around 0.004 inches or around 0.008 inches. The rounded circumferential ridge acts to increase the interference fit between the annular wall 826 and the bore 15. There may be an audible click when the annular wall 826 and the bore 15 are brought into and out of engagement.

The rounded circumferential ridge also acts to promote seize between the annular wall 826 and the bore 15, which is further promoted by selecting similar polymeric materials for the annular wall 826 and the bore 15. For instance, the annular wall 826 and the bore 15 may both be made from polypropylene.

By providing an enhanced interference fit and/or increased seize, the bore plug seal may be improved. Consequently, the container 1 may be less prone to leaking than prior art containers.

Outside the annular wall 826, there are two arcuate clip features 827a, 827b. The arcuate clip features 827a, 827b are taller than the annular wall 826. The rigidity of the arcuate clip features 827a, 827b is improved by the provision of six substantially vertical outer reinforcing ribs (only two of the outer reinforcing ribs 828e, 828f are labelled for clarity). On the inner side of each arcuate clip feature 827a, 827b, there is an elongate bump (not shown). The elongate bumps are configured such that, when the closure 803 is coupled to the container body 2, the elongate bumps have passed over the ramp formation 17. Accordingly, the bumps engage with the ramp formation to resist removal of the closure 803 from the container body 2.

Within the cap body 808, there are also four anti-rotation ribs 829a, 829b, 829c, 829d. Each anti-rotation rib 829a, 829b, 829c, 829d is strengthened by a connecting rib 830a, 830b, 830c, 830d extending perpendicularly from the anti-rotation rib and connecting the anti-rotation rib to an end wall of the cap body 808. In use, anti-rotation ribs 829a, 829b and connecting ribs 830a, 830b sit either side of shoulder formation 14a and anti-rotation ribs 829c, 829d and connecting ribs 830c, 830d sit either side of shoulder formation 14b.

FIG. 9 shows a view of the underside of a fourth example embodiment of a closure 903 according to the invention. The closure 903 comprises a cap body 908 having the same tapered general shape as described earlier in relation to other example embodiments. The embodiment shown in FIG. 9 is identical to the embodiment shown in FIG. 6, except that it includes four arcuate clip feature connecting ribs 931a, 931b, 931c, 931d.

Within the cap body 908, there are several formations and features. An orifice 919 is surrounded by an annular wall 926. When the closure 903 is coupled to the container body 2, the annular wall 926 plugs the bore 15. An interference fit between the annular wall 926 and the bore 15 provides a bore plug seal. On the outside of the annular wall 926, there is a rounded circumferential ridge, which locally increases the outer diameter of the annular wall 926. The rounded cicumferential ridge may increase the local outer diameter of the annular wall by around 0.004 inches or around 0.008 inches. The rounded circumferential ridge acts to increase the interference fit between the annular wall 926 and the bore 15. There may be an audible click when the annular wall 926 and the bore 15 are brought into and out of engagement.

The rounded circumferential ridge also acts to promote seize between the annular wall 926 and the bore 15, which is further promoted by selecting similar polymeric materials for the annular wall 926 and the bore 15. For instance, the annular wall 926 and the bore 15 may both be made from polypropylene.

By providing an enhanced interference fit and/or increased seize, the bore plug seal may be improved. Consequently, the container 1 may be less prone to leaking than prior art containers.

Outside the annular wall 926, there are two arcuate clip features 927a, 927b. The arcuate clip features 927a, 927b are taller than the annular wall 926. The rigidity of the arcuate clip features 927a, 927b is improved by the provision of six substantially vertical outer reinforcing ribs (only two of the outer reinforcing ribs 928e, 928f are labelled for clarity). In addition, the rigidity of the arcuate clip features 927a, 927b is further increased by arcuate clip feature connecting ribs 931a, 931b, 931c, 931d, which connect the ends of the arcuate clip features 927a, 927b to the inside of the outer wall of the cap body 908.

On the inner side of each arcuate clip feature 927a, 927b, there is an elongate bump (not shown). The elongate bumps are configured such that, when the closure 903 is coupled to the container body 2, the elongate bumps have passed over the ramp formation 17. Accordingly, the bumps engage with the ramp formation to resist removal of the closure 903 from the container body 2.

FIG. 10 shows a view of the underside of a fifth example embodiment of a closure 1003 according to the invention. The closure 1003 comprises a cap body 1008 having the same tapered general shape as described earlier in relation to other example embodiments. The embodiment shown in FIG. 10 is identical to the embodiment shown in FIGS. 5 and 7, except that it also includes four arcuate clip feature connecting ribs 1031a, 1031b, 1031c, 1031d, as described in relation to the fourth example embodiment shown in FIG. 9. Equivalent features from FIGS. 5, 7 and 9 have reference numerals sharing the same last one or two digits.

Containers according to the technology described herein were subjected to a number of tests, in order to assess their performance. The results for these containers were compared with some benchmarks.

### Static Seal Integrity Test

This test assesses seal integrity when the container is subjected to static load on the sides. The test is intended to measure the resistance of the container body and closure to leakage during an everyday situation.

### Summary of Test Procedure

All tests are conducted at ambient (64 to 71° F.) and 50% to 70% r/h
Filled closed containers, post normalisation, are placed on their sides on clean absorbent paper on a suitable water resistant flat surface.
A 4.5 lb weight is placed on each bottle for 2 hours.
Any seal integrity failures are highlighted by the absorbent paper.
The test is passed when no containers fail.
A more stringent test is to use a 9 lb weight in place of the 4.5 lb weight.

### Test Results

This container: 4.5 lb=Pass, 9 lb=Pass Benchmark A: 4.5 lb=Pass, 9 lb=Pass Benchmark B: 4.5 lb=Pass, 9 lb=Fail (88% passed)

### Dynamic Seal Integrity Test

This test assesses seal integrity when the container is subjected to dynamic load on the sides. The test is intended to measure the resistance of the container body and closure to leakage during an everyday situation.

### Summary of Test Procedure

All tests are conducted at ambient (64 to 71° F.) and 50% to 70% r/h
Filled closed containers, post normalisation, are placed on their sides in mechanical compression equipment where the speed of compression can be controlled.
At a set and repeatable speed of 1 inch/min, the containers are subject to increasing force.
Any seal integrity failures are highlighted by any form of leakage from the container or closure, and the peak force recorded.
If a set (safe) limit is reached for the test equipment (110 lbf) then a simple pass is recorded and the container is unloaded promptly.

### Test Results

This container: 107 lbf=15%, Pass 110 lbf=85%
Benchmark A: 76.5 lbf=100%, Pass 110 lbf=0%
Benchmark B: 102.5 lbf=60%, Pass 110 lbf=40%

### Closure Torque Resistance

This test assesses the resistance to rotation of the closure on the container body when the closure is subjected to torque (rotational force). The test is intended to measure the point at which the closure rotates on the container body.

### Summary of Test Procedure

All tests are conducted at ambient (64 to 71° F.) and 50% to 70% r/h
Filled closed containers, post normalisation, are placed in the restraining mechanism of mechanical torque testing equipment
Torque is then applied gradually to the closure until the closure rotates on the container.
The peak torque (ft.lbs) is recorded.
If a set (safe) limit is reached for the test equipment (5 ft.lbs) then a simple pass is recorded and the container is unloaded promptly.

### Test Results

This container: <5 ft.lbs=0%, Pass 5 ft.lbs=100%
Benchmark A: 1.5 ft.lbs=100%, Pass 5 ft.lbs=0%
Benchmark B: 1.1 ft.lbs=100%, Pass 5 ft.lbs=0%

### Closure Removal Resistance

This test assesses the resistance of the closure to being removed by pulling. The test is intended to measure the force required to break the closure free from the container in a linear motion parallel to the centreline of the container.

### Summary of Test Procedure

All tests are conducted at ambient (64 to 71° F.) and 50% to 70% r/h
Filled closed containers, post normalisation, are placed upright in the restraining mechanisms of the mechanical tension equipment, where only the container is so restrained to prevent vertical movement and the speed of application tension can be controlled.
The closure is then attached to the moving part of the equipment such that it can be pulled free of the container
At a set and repeatable speed of 1 inch/min, the containers are subject to increasing tension until they are removed from the container
The peak force recorded to pull the closure from the container.

### Test Results

This container: 15.5 lbf

### Benchmark A: 12.0 lbf

### Benchmark B: 12.5 lbf

References in the test data to “this container” refer to a container as illustrated in FIGS. 1 and 2.

It will be appreciated that the technology described herein may provide an improved container for dispensing multiple doses of a liquid concentrate. The container described herein may be less prone to leaking than prior art containers and/or may be more robust by being more resistant to accidental opening.

The technology described herein may also provide a packaged flowable substance comprising a container as described herein with a plurality of doses of the flowable substance therein. Conveniently, the flowable substance may be a liquid concentrate, e.g. a beverage liquid concentrate.

Various modifications to the disclosed example embodiments of the invention may occur to the person skilled in the art without departing from the spirit and scope of the invention.

1. A container for dispensing multiple doses of a flowable substance comprising:
a container body defining an internal volume for holding the flowable substance and an outlet from the internal volume; and
a closure coupled to the container body, the closure comprising an orifice in fluid communication with the outlet;
wherein the container body and the closure are configured such that a torque in excess of 1.5 ft.lbs is required to be applied in order to remove the closure from the container body by twisting.

2. The container of claim 1, wherein the container body and/or the closure comprise at least one anti-rotation feature, operable to resist, in use, rotation of the closure with respect to the container body.

3. The container of claim 1, further comprising a closable lid operable, in use, to cover and uncover the orifice.

4. A container for dispensing multiple doses of a flowable substance comprising:
a container body defining an internal volume for holding the flowable substance and a neck comprising a bore defining an outlet from the internal volume;
a closure coupled to the container body, the closure comprising an orifice in fluid communication with the outlet and an annular wall configured to provide, in use, a bore plug seal within the bore;
wherein there is an interference fit between the annular wall and the bore.

5. The container of claim 4, wherein the force required to decouple the closure from the container body by linearly pulling the closure off the container body is greater than 9 lb.

6. The container of claim 4, wherein the outer diameter of the annular wall is at least 0.008 inches greater than the inner diameter of the bore.

7. The container of claim 6, wherein the difference between the outer diameter of the annular wall and the inner diameter of the bore is between 0.02 and 0.2 inches.

8. The container of claim 4, further comprising an at least partially circumferential ridge on the outside of the annular wall.

9. The container of claim 8, wherein the at least partially circumferential ridge increases the local outer diameter of the annular wall.

10. The container of claim 8, wherein the at least partially circumferential ridge increases the local outer diameter of the annular wall by at least 0.004 inches.

11. The container of claim 4, wherein the annular wall and the bore are made from the same or chemically similar polymeric materials.

12. The container of claim 4, wherein the closure further comprises one or more arcuate clip features configured to engage with an outer wall of the neck.

13. The container of claim 12, wherein said one or more arcuate clip feature(s) is/are provided with one or more outer reinforcing ribs.

14. The container of claim 12, wherein said one or more arcuate clip feature(s) further comprise(s) one or more bumps configured to pass over a ramp formation on the neck when the closure is coupled with the container body.

15. A container for dispensing multiple doses of a flowable substance comprising:
a container body defining an internal volume for holding the flowable substance and an outlet from the internal volume; and
a closure coupled to the container body, the closure comprising an orifice in fluid communication with the outlet;
wherein the container body and/or the closure comprises at least one anti-rotation feature, operable to resist, in use, rotation of the closure with respect to the container body.

16. The container of claim 15, wherein the container body and the closure are configured such that a torque in excess of 1.5 ft.lbs is required to be applied in order to remove the closure from the container body by twisting.

17. The container of claim 15, wherein the anti-rotation feature comprises one or more protrusions provided on the container body or in the closure and one or more slots or gaps provided on or in the other of the container body and the closure, the protrusion(s) being receivable within the slot(s) or gap(s) such that, in use, the protrusion(s) and the slot(s) or gap(s) interact to resist rotation of the closure relative to the container body.

18. The container of claim 17, wherein the one or more protrusions are shoulder formations.

19. A packaged flowable substance comprising a container according to claim 1 with a plurality of doses of the flowable substance therein.

20. The packaged flowable substance of claim 19, wherein the flowable substance is a liquid beverage concentrate.
